(19) United States
(12) Patent Application Publication
(10) Pub. No.: US 2005/0066746 A1
(43) Pub. Date: Mar. 31, 2005

(54) Meter transmitter/receiver and method of manufacturing same for use in a water-containing environment

(76) Inventor: Dan Winter, Pardessia (IL)

Correspondence Address: Paul M. Reznick;WEBB ZIESENHEIM LOGSDON ORKIN & HANSON, P.C., 700 Koppers Building, 436 Seventh Avenue, Pittsburgh, PA, 15219-1818, US

(21) Appl. No.: 10/864,313

(22) Filed: Jun. 9, 2004

Related U.S. Application Data
(60) Provisional application No. 60/478,204, filed on Jun. 13, 2003.
(60) Provisional application No. 60/478,309, filed on Jun. 13, 2003.
(60) Provisional application No. 60/479,557, filed on Jun. 17, 2003.

(51) Int. Cl. H04L 7/00

(52) U.S. Cl. 73/861.42

(57) ABSTRACT

The signal from a meter register of a water meter having a distance range is transmitted to a receiver mounted adjacent the meter register and acted on to provide a second signal that has a predetermined distance range greater than the predetermined distance of the received signal. The second signal is transmitted to a meter reader. Reed switches are mounted alongside a meter register of a water meter and acted on by magnetic end of a rotating arm of the register. A microprocessor receives signals from the reed switches and determines water flow direction and units of flowed water. The information is transmitted to a meter reader. Components of a transmitter/receiver are mounted in a housing and the housing partially filled with silicone gel and polyurethane. The transmitter/receiver can be used in dry, damp, and wet environments.

### CROSS REFERENCE TO RELATED APPLICATIONS

This application claims the benefit of U.S. Provisional Application Ser. Nos. 60/478,204, filed Jun. 13, 2003; 60/478,309, filed Jun. 13, 2003; and 60/479,557, filed Jun. 17, 2003, which applications are hereby incorporated by reference in their entirety.

### BACKGROUND OF THE INVENTION

1. Field of the Invention

The present invention relates to a transmitter/receiver for use with meters for measuring material flows operating in different environments and, more particularly, to a signal transmitter/receiver for receiving a first signal from a water meter having a low power transmission and for transmitting a second signal from a higher power transmitter, the transmitter/receiver operating in dry, moist, and/or wet environments. The present invention also relates to a method of manufacturing the transmitter/receiver to operate in the different environments.

2. Description of Related Art

Meters, such as water meters and gas meters, measure the quantity and, in some cases, the flow rate of material passing through the meter. In general, these meters include meter registers that are coupled to the measuring chamber of the meter body and record the volume of material flowing through the meter. Early designs of the water meters had the meter registers directly coupled to the measuring chambers. This coupling included a drive shaft attached to an element of the drive chamber, which then drove a plurality of gears in the meter register driving an odometer. Although the early design of water meters using the gear arrangements were reliable, there were drawbacks, e.g., they were expensive, the friction caused by the gears affected the accuracy of the measuring chamber, and they required an individual, e.g., a meter reader, to visually read the meter register and record the amount of material that flowed through the meter for a given period.

Subsequently, the meter registers and measuring chambers were redesigned from a gear coupling arrangement to magnetic couplings. The magnetic coupling permitted the use of sealed meter registers. Although the sealed meter register eliminated the expense of, and the inaccuracies caused by, the gear coupling, they did not eliminate the need of a meter reader to visually read the meter register and record the amount of flowed material. After the development of the sealed meter register, automated meter reading systems were developed. One type of system is disclosed in U.S. Pat. No. 5,111,407, which is hereby incorporated by reference. The meter reading system described in the above-identified patent eliminated the necessity of the meter reader to visually read the meter register and write down the meter register reading. A meter utilizing this technology is manufactured by Master Meter, Inc. and Arad, Ltd. and sold under the Dialog® D trademark. Although the automated meter reading system eliminated the need to visually read the meter register, it still required a meter reader to go to a vicinity near the water meter where the transmitter or transponder is accessible and take a reading from the meter via a hand-held wand or receiver. The necessity of going to the vicinity near the water meter is due to the short transmitting range of the transmitter or transponder of the meter.

The limitation of using the wand was eliminated by the development of electronic meter registers because electronic meter registers permit a transmission of radio signals a greater distance than that of the prior described automated meter-reading systems. Electronic meter registers are disclosed in PCT Publication No. WO 02/073735 (hereinafter also referred to as “WO 02/073735”), which is hereby incorporated by reference. Meters utilizing the radio frequency electronic-type meter register disclosed in WO 02/073735 are manufactured by Master Meter, Inc. and Arad Technologies, Inc. and sold under the Dialog 3G trademark. Therefore, it is an object of the present invention to permit conversion of automated meter systems, e.g., Dialog® systems, to meters using radio frequency electronics, e.g., Dialog 3G radio systems, thereby having the automated systems operate under a more modem technology.

The meters using the radio frequency electronics are preferred over the automated meter systems because, among other things, they permit meter register readings from distant locations. However, to convert meters using automated meter systems, e.g., Dialog® systems, to meters using radio frequency electronics, e.g., Dialog 3G radio systems, is a costly endeavor and is usually rejected by most utilities. Another concern is that many of the meters using the automated meter systems are located in water-containing environments, e.g., in pits that are, at times, flooded and/or have high humidity. Such an environment can be detrimental to the electronics used in radio transmitters/receivers. Therefore, it is a further object of the present invention to provide a transmitter/receiver that can operate in dry, moist, and wet environments.

Further, an additional object of the present invention is to combine the previous objects; more particularly, to permit conversion of automated meter systems, e.g., Dialog® systems, to meters using radio frequency electronics, e.g., Dialog 3G radio systems, thereby having the automated systems operate under a more modern technology regardless of the humidity of the environment in which they operate.

### SUMMARY OF THE INVENTION

The present invention is a clamp-on unit adapted to co-act with a meter that transmits out one type of signal and converts it into a second type of signal.

More particularly, the meter includes a meter body, a meter register registered to the meter body, wherein the meter register transmits an RF signal therefrom, a clamp attached to the meter, and a transmitter/receiver received by the clamp, wherein the transmitter/receiver receives the RF signal transmitted by the meter register and transmits another signal to be read by a meter-reading device.

In another non-limiting embodiment of the invention, a clamp for use with a meter has a meter body and a meter register that transmits a radio signal, the clamp includes a body for receipt of the meter register, the body of the clamp having an arrangement to secure the body of the clamp to the meter body, and a transmitter/receiver for communication with the register via a radio signal attached to the clamp.

The invention further relates to an improved meter for measuring material flow, e.g., a water meter, wherein the meter is of the type having a meter body having a cavity through which material can flow, a material displacement arrangement in the cavity, the material displacement arrangement responsive to material moving through the meter, a register, e.g., meter register, acted on by the material displacement arrangement, the register having components to determine the amount of flowed material to generate a signal having information regarding amount of flowed material through the meter, and to transmit the signal, wherein the transmitted signal has a predetermined distance. The improved meter includes a receiver mounting the meter body to receive the transmitted signal from the register, defined as a first signal, and a signal converter connected to the receiver and acting on the first signal to convert the first signal to a second signal, wherein transmission range of the second signal has a predetermined distance greater than the predetermined distance of the first signal.

The invention further relates to an improved meter for measuring material flow, e.g., a water meter, wherein the meter is of the type having a meter body having a cavity through which material can flow, a material displacement arrangement in the cavity responsive to material moving through the meter, a register acted on by the material displacement arrangement to determine the amount of flowed material, the register includes a rotating arm mounted for rotation in a clockwise and a counterclockwise direction depending on the direction of the material flow. The improvement includes a magnet on an end portion of the rotating arm, and a pair of reed switches mounted outside the meter body and the register and acted by the magnet as the arm moves past the reed switches.

A further embodiment of the invention relates to an improved transmitter and receiver of the type having a housing and components in the housing to receive a signal, convert the signal and transmit the signal, and a power source. The improvement includes a material selected from the group of moisture-impervious or moisture-resistant material in the housing and covering selected portions of components in the housing. In a non-limiting embodiment of the invention, silicone gel fills a portion of the interior of the housing and the remainder is filled with different moisture-impervious or moisture-resistant material.

A still further embodiment of the invention relates to a method for manufacturing a transmitter/receiver for use with a water meter in a pit and includes the steps of providing a body having a cavity, attaching electronics to the body within the cavity, partially filling a cavity defined by the body with a silicone gel, attaching a cap to the body, filling the remainder of the body cavity with polyurethane, and permitting the polyurethane to cure.

The present invention is a method of manufacturing a transmitter/receiver device for use with a meter. The method includes the steps of providing an outer casing made of a polymer material, which has strength and moisture resistance, such as an ABS and polycarbonate combination polymer. The casing has a cavity defined therein. The next step is providing electronic hardware for transmitting and receiving RF (radio frequency) signals within the cavity. Then, the next step is providing a silicone gel in the cavity to encase only a portion of the electronics. Then, an end cap is attached to the casing, enclosing the electronic and silicone gel. The end cap includes an inlet port and an outlet port. A sealing material, such as a polyurethane material, is injected into the inlet port of the end cap filling the remaining portion of the cavity. Finally, the materials are permitted to cure, which also securely fastens the end cap to the casing.

### BRIEF DESCRIPTION OF THE DRAWINGS

FIG. 1 is a side elevated view of a prior art water meter having portions removed for purposes of clarity;

FIG. 2 is a top elevational view of the water meter shown in FIG. 1;

FIG. 3 is an orthogonal view of a transmitter/receiver arrangement incorporating features of the invention;

FIG. 4 is a top perspective view of a water meter having a transmitter/receiver arrangement made in accordance with the teachings of the present invention;

FIG. 5 is a top plan view of another non-limiting embodiment of a transmitter/receiver of the invention mounted on a water meter measuring the water flowing through the meter;

FIG. 6 is a chart showing signals as the meter shown in FIG. 5 monitors water flow through the meter;

FIG. 7 is a front plan view of the housing and cap for encapsulating the transmitter/receiver made in accordance with the present invention;

FIG. 8 is back plan view of the transmitter/receiver of the invention showing internal components in phantom; and

FIG. 9 is a bottom elevational view of the transmitter/receiver shown in FIG. 8.

### DETAILED DESCRIPTION OF THE INVENTION

In the following discussion of the non-limiting embodiments of the invention, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”; Accordingly, unless indicated to the contrary, the numerical values set forth in the following specification and claims can vary depending upon the desired properties sought to be obtained by the practice of the invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, and all subranges in between, e.g., 1 to 6.3, or 5.5 to 10, or 2.7 to 6.1. Also, as used herein, terms such as “positioned on” or “supported on” mean positioned or supported on but not necessarily in direct contact with the surface.

Further, in the discussion of the non-limiting embodiments of the invention, it is understood that the invention is not limited in its application to the details of the particular non-limiting embodiments shown and discussed since the invention is capable of other embodiments. Further, the terminology used herein is for the purpose of description and not of limitation and, unless indicated otherwise, like reference numbers refer to like elements.

The non-limiting embodiments of the invention are discussed for use on a water meter; however, as will be appreciated, the invention is not limited thereto, and the non-limiting embodiments of the invention can be used with any type of signal transmitting device, e.g., but not limiting the invention thereto, any type of signal transmitting meter measuring the movement of materials, e.g., but not limiting the invention thereto, fluids, such as water and gas. Although not limiting to the invention, the water meter in the following discussion is a Dialog Multi-jet Meter Register manufactured by Master Meter, Inc. and Arad, Ltd. and sold under the trademark Dialog®.

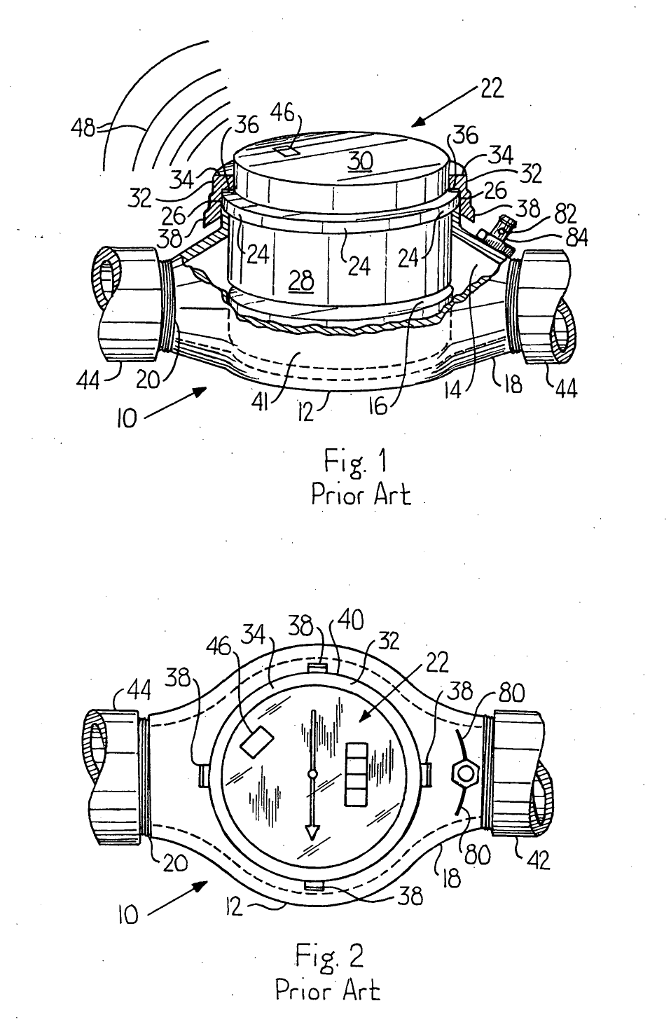

FIG. 1 shows a prior art water meter 10. The meter 10 has a body 12 having an open-ended internal passageway 14, a measuring chamber 16 communicating with the passageway 14, an inlet connection 18, an outlet connection 20, and a meter register 22. The meter register 22 has a ridge 24 extending outwardly from the center portion of the meter register 22 and mounted on stepped ledge 26 of the open end of the passageway 14 to support the meter register 22 such that lower portion 28 of the meter register 22 extends through the passageway 14 to the measuring chamber 16, and upper portion 30 of the meter register 22 extends above the stepped outer ledge 26 of the passageway 14.

Referring now to FIGS. 1 and 2, the meter register 22 is secured in the passageway 14 of the meter body 12 by an internally threaded securing ring 32 having an upper ledge 34 to engage a gasket 36 (shown only in FIG. 1) mounted on upper surface of the ridge 24 of the meter register 22. Four equally spaced lugs 38 are provided on circumferential surface 40 of the securing ring 32 to assist in rotating the ring 32 to compress the gasket 36 to provide a watertight seal.

The body 12 of the water meter 10 is preferably made of a metallic material, such as bronze, copper, or stainless steel, although it can be made of other materials, e.g., plastic. The measuring chamber 16 can contain any one of the measuring-type arrangements 41 (see FIG. 1) known in the art, such as positive displacement arrangement or a vane or a multi-jet type displacement arrangement. The inlet connection 18 and the outlet connection 20 are adapted to be secured to pipes 42 and 44, respectively. The meter register 22 is preferably sealed and magnetically coupled to the magnetic drive arrangement 41 in the measuring chamber 16. Magnetic drive arrangements are well known in the art and no further discussion is deemed necessary. The meter register 22 is of the type known in the art under the trademark Dialog®. The meter register 22 measures the water flow and includes a low-powered transmitter or antenna 46, which transmits signals 48. Further, the transmitter 46, shown in FIGS. 1 and 2, is mounted on an outer surface of the meter register 22. The invention, however, is not limited thereto and the transmitter 46 can be housed within the meter register 22. The meter register 22 is of the type described in U.S. Pat. No. 5,111,407, sold under the Dialog® trademark, and has a low power transmitter which can only transmit the signal for a short distance, e.g., several inches at most.

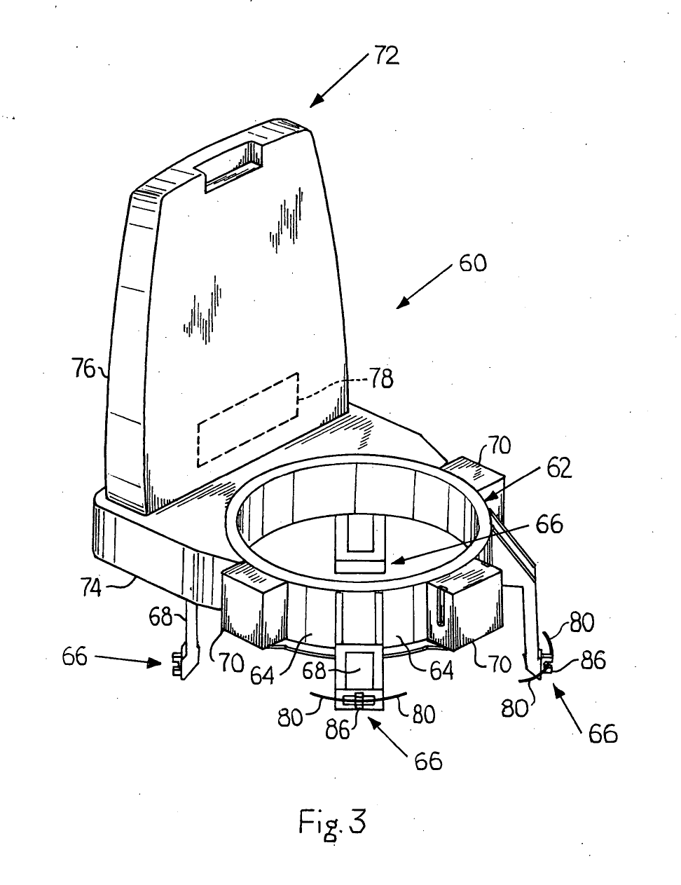

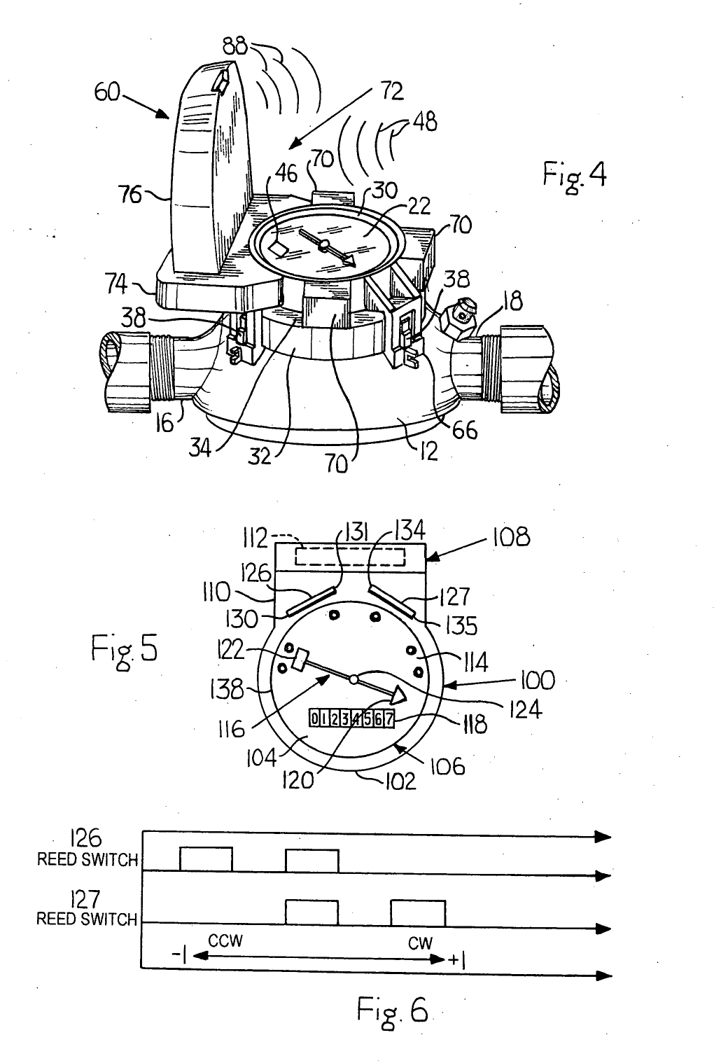

In accordance with the practice of the invention, the signal from the transmitter 46 is received by a receiver and converted to a radio frequency (“RF”) signal, e.g., an RF signal similar to the type transmitted by the Dialog 3G meter register, and the signal transmitted up to several miles. More particularly, and with reference to FIG. 3, there is shown a transmitter/receiver arrangement 60 incorporating features of the invention that can be mounted on the meter body 12. More particularly, and with reference to FIGS. 3 and 4, the transmitter/receiver arrangement 60 (hereinafter also referred to as the “transmitter arrangement”) includes an endless strap or engaging ring 62 sized to slip over the upper portion 30 of the meter register 22 and supported on the upper ledge 34 of the securing ring 32 as shown in FIG. 4.

Mounted on outer surface 64 of the engaging ring 62 are four equally spaced flexible engaging members 66. Each member 66 has a cut out 68 sized to receive one of the lugs 38 mounted on the circumferential surface 40 of the securing ring 32 when the engaging ring 62 is supported on the upper ledge 34 of the securing ring 32 (see FIGS. 2 and 4). Also mounted on the outer surface 64 of the engaging ring 62 are a three spaced block members 70 (spaced approximately 90° apart) that rest on the upper ledge 34 of the securing ring 32 to prevent rocking of the transmitter arrangement 60 when it is mounted on the securing ring 32.

With continued reference to FIG. 3, the transmitter arrangement 60 includes a transmitting tower 72 mounted on a platform 74 secured to the engaging ring 62. The tower 72 includes a hollow housing 76 having electronics, e.g., but not limiting the invention thereto, a microprocessor, to convert the signal received from the meter register 22 to an RF signal, a power unit, e.g., but not limiting the invention thereto, a battery, and an antenna, e.g., but not limiting the invention thereto, a signal transmitter and receiver. In FIG. 3, internal components of the tower including, but not limited to, the electronics, power unit, and antenna are shown in phantom and identified by the number 78. The radio frequency receiver of the internal components 78 is similar to the receiver used with the Dialog® meter register to receive the signal from the transmitter 46 of the meter register 22. The received RF signal is converted via the microprocessor of the internal components 78 to a corresponding Dialog 3G type RF signal and emitted to a reading device as described in WO 02/073735. Components to receive and convert signals, e.g., from the meter register 22, and to transmit signals, e.g., to a reading device as described in WO 02/073735, are well known in the art and no further discussion regarding such components is deemed necessary.

The invention is not limited to the material of the transmitter/receiver arrangement 60, e.g., but not limiting to the invention, the transmitter arrangement can be made of plastic and/or fiberglass-reinforced plastic. Preferably, the engaging ring 62 and platform 74 are made of plastic so that it may easily be fitted as previously discussed onto the existing meter 10 and, preferably, the housing 76 transmitter arrangement is made of a polymeric material, which is a combination of ABS and polycarbonate which has strength and moisture resistance. The advantage of making the housing 76 of a moisture-resistant material is discussed below. Further, the invention is not limited to the manner in which the transmitter arrangement is made, e.g., but not limiting to the invention, the transmitter arrangement can be molded as a single part or several pieces which are subsequently joined together. In the practice of the invention, the platform 74, engaging ring 62, block member 70, and flexible engaging members 66 were molded as a unitary piece. The housing 76 was molded separately after which the internal components 78 to receive signals, and to convert and transmit the received signals, were secured in the housing 76, and the housing 76 secured to the platform 74 in any convenient manner, e.g., but not limiting the invention thereto, by an adhesive.

Prior to positioning the engaging ring 62 over the upper portion 30 of the meter register 22, any obstruction is removed, e.g., a lid of the meter, if present. The engaging ring 62 is placed over the upper portion 30 of the meter register 22 and positioned on the upper ledge 34 of the securing ring 32 with the flexible member 66 moved toward the lugs 38 to move the lugs through the cut outs 68 of the flexible members 66. A wire 80 (see FIG. 2) is passed through a wire passage 82 in adjustment control valve 84 (see FIG. 1) and in grooves 86 of the flexible members 66 of the transmitter arrangement 60 (see FIG. 3). The wire 80 is a tamper-proof wire which will indicate tampering of the transmitter arrangement 60. As can be appreciated, the invention contemplates the use of holes in place of the grooves 86 of the flexible members 66.

In the present embodiment of the invention, the Dialog-type meter can be converted into a Dialog 3G-type protocol through a field installation of the transmitter/receiver arrangement 60 incorporating features of the invention. More particularly, the transmitter 46 of the meter register 22 (see FIGS. 1 and 2) transmits an RF signal 48 in Dialog format to the internal components 78 in the housing 76 of the transmitter arrangement 60 (see FIGS. 3 and 4), the internal components 78 read and convert the RF signal 48 to a Dialog 3G format (a signal that is transmitted longer distances than the signal received from the meter register). The internal components 78 then transmit a Dialog 3G RF signal (see FIG. 4). This enables a utility to convert to a single Dialog 3G protocol through a simple clamp-on arrangement. Further, the present invention need not be limited to one sort of meter arrangement or protocol and can be used to amplify and transmit a protocol other than the Dialog 3G protocol to enable the meter to be utilized with other types of meter reading systems. Further, the present invention could, likewise, be modified via the engaging ring 62 (see FIG. 3) to accept other types of meter bodies that have the Dialog protocol or other type of reading protocol.

The invention contemplates adapting the transmitter/receiver arrangement of the invention to determine flow volume and direction of flow. More particularly and with reference to FIG. 5, there is shown a transmitter/receiver arrangement (hereinafter also referred to as “transmitter arrangement”) 100 having an engaging ring 102 to secure the transmitter arrangement 100 to an upper portion 104 of a meter register 106, with a tower 108 secured to a platform 110. The tower 108 houses the internal components 112 (shown in phantom in FIG. 5) similar to the internal components 78 of the transmitting tower 72 shown in FIG. 3. The tower 108 is mounted in close proximity to the meter register 106 in a manner similar to the mounting of the tower 72 in close proximity to the meter register 22. The meter register 106 has a face plate 114, a sweep hand 116, and an odometer 118. The sweep hand 116 has an arrow or pointer 120 at one end and a magnet 122 at the opposite end. The sweep hand 116 rotates about an axis 124. Although in the practice of this embodiment of the invention, it is preferred to use meter registers having a magnet at one end of the sweep hand, e.g., meter registers sold under the trademark Dialog®, the invention can be practiced where the sweep hand can be modified by adding magnetic film, e.g., adhesive film to the end of the sweep arm opposite the pointer.

The platform 110 or the tower 108 includes two reed switches. In the non-limiting embodiment shown in FIG. 5, reed switches 126 and 127 are mounted on the platform 110 and connected to the internal components 112 in any conventional manner. The reed switches 126 and 127 are in close proximity to the circular path followed by the sweep hand 116 and, preferably, but not limiting to the invention, in the same imaginary plane as the magnet 122. The reed switches 126 and 127 are of the type that are normally open or deactivated; or are closed or activated when a magnet is in close proximity to their respective ends 130, 131 and 134, 135 and are open or deactivated when the magnet 122 is in proximity to the middle of the reed switches 126 and 127. Each of the reed switches 126 and 127 preferably, but not limiting to the invention, have a line normal to their center with the lines intersecting one another at an angle of 90° and close to being tangent to outer perimeter 138 of the upper portion 104 of the meter register 106. The adjacent ends 131 and 134 of the reed switches 126 and 127, respectively, are spaced such that with the magnet equidistant from the ends 131 and 134 of the reed switches 126 and 127, respectively, both reed switches are either closed or activated.

The reed switches 126 and 127 are coupled to a microprocessor (not shown) of the internal components 112 housed in the tower 108. When the magnet 122 moving in a clockwise direction, as viewed in FIG. 5, is in close proximity to end 130 of the reed switch 126, the reed switch 126 is closed. Continued clockwise rotation of the magnet 122, towards the middle of the reed switch 126, opens or deactivates the reed switch 126. Continued clockwise movement of the magnet 122 to the end 131 of the reed switch 126, closes the reed switch 126. The magnet continues a clockwise rotation and moves to a position between the ends 131 and 134 of the reed switches 126 and 127 to close both reed switches. Continued rotation of the sweep hand 116 in the clockwise direction causes the magnet 122 to move closer to end 134 of the reed switch 127 to open the switch 126 and maintain the switch 127 closed. The magnet 122 rotates to a position between ends 134 and 135 of the reed switch 127, which opens the reed switch 127. Both reed switches 126 and 127 are now open. Continued rotation of the magnet 122 in the clockwise direction moves the magnet 122 in close proximity to the end 135 of the reed switch 127, causing the reed switch 127 to close. Continued clockwise rotation of the magnet 122 moves the magnet 122 away from the end 135 of the switch 127 to open the switch 127. Both switches 126 and 127 are now open and remain open to complete one cycle. The switches 126 and 127 remain open until the magnet 122 moves in close proximity to the end 130 of the switch 126, at which time the cycle is repeated. The magnet 122 rotating in a counterclockwise direction opens and closes the ends of the reed switches in the reverse order, e.g., the end 135 of the switch 127 is the first end to close.

Although not limiting to the invention, the microprocessor (not shown) of the internal components 112 of the tower 108 is programmed to separately read the position of each reed switch 126 and 127 as a “1” when the switch is closed and “0” when the switch is open. In this manner, the microprocessor can determine flow volume (one revolution of the magnet equals a fixed volume) as well as direction of flow, as shown by the representation in FIG. 6, where magnet 122 moves in the clockwise (“CW”) direction or counterclockwise (“CCW”) direction. One complete cycle results in a “count” that can then be summed by the microprocessor and a signal transmitted to be read corresponding to the “counts” or volumetric flow through the meter 10 as measured by the magnet 122 acting on the reed switches 126 and 127 as previously discussed.

As can be appreciated, the invention contemplates using features of the invention to amplify the radio signals and using reed switches to determine material flow separately or in combination with one another.

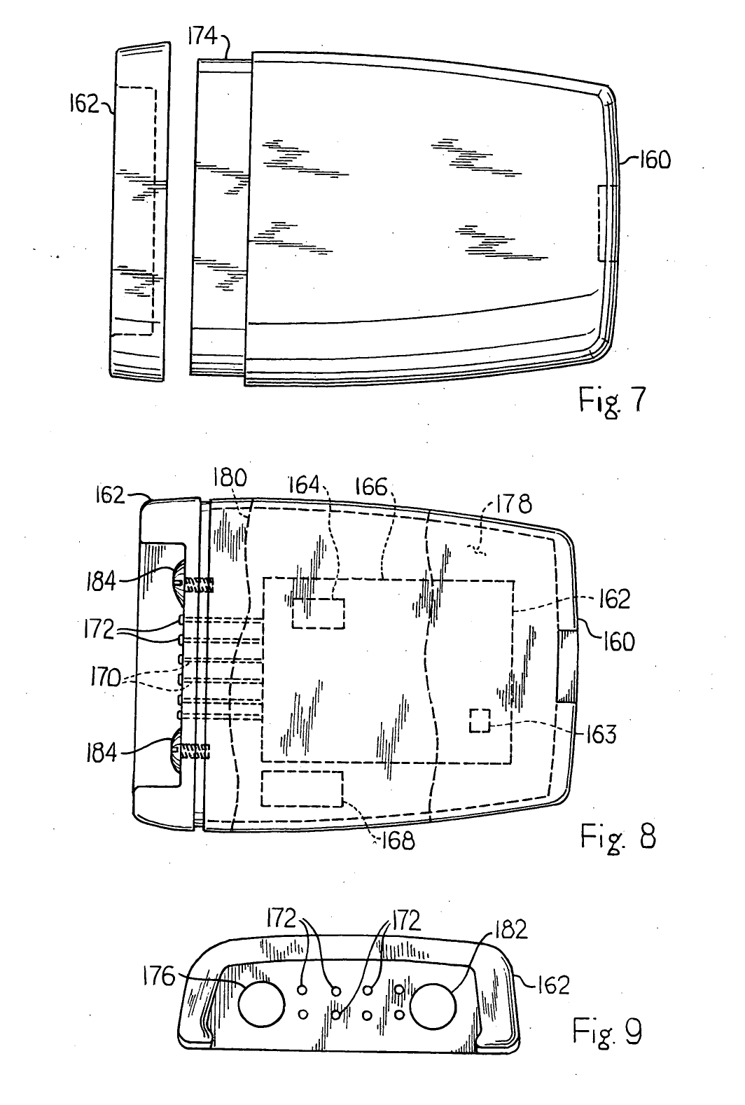

In the following non-limiting embodiment of the invention, the transmitter/receiver of the invention is manufactured for use in any type of environment, e.g., a dry, damp, and/or wet environment, e.g., but not limiting to the invention, for use in a pit (not shown). Referring to FIG. 7, there is shown a hollow open-ended housing 160 similar to the housing 76 of the transmitter arrangement 60 shown in FIG. 3. The housing 160 can be mounted on the platform 74 for attachment to a water meter as previously discussed or can be capped with end cap 162 and mounted on a wall of a structure, e.g., but not limiting to the invention, the outside of a home, apartment building, or commercial building. In the following discussion, the embodiment of the invention is discussed with the transmitter/receiver mounted on a support other than a meter for measuring material flow.

Preferably, the housing 160 is made of a polymeric material, which is a combination of ABS and polycarbonate. This material is chosen for its strength and moisture resistance. Internal components shown as 163 and 164 to receive signals, amplify the signals and forward the signals to a receiver (not shown), are mounted on a circuit board 166. The circuit board 166, having the predetermined circuitry to accomplish the desired purpose, and one or more batteries 168 (only one shown in FIG. 8) are mounted inside the hollow open-ended housing 160, as shown in phantom in FIG. 8. Thereafter, cap wires 170 having one end connected to the circuit board 166 and the other end connected to screws 172 are mounted in the end cap 162 (also see FIG. 9). Thereafter, the end cap 162 is joined to end portion 174 (shown in FIG. 7) of the housing 160 and secured thereto, e.g., by an adhesive.

A moisture-resistant or moisture-absorbing material, such as halogenated polymeric material including polyvinylidene chloride, polyvinylidene fluoride, polyvinyl chloride or polytrichlorofluoro ethylene, moisture-impervious hot melts and silicone gel is moved through hole 176 in the end cap 162 (clearly shown in FIG. 9) into the housing 160. In the practice of the invention, a silicone gel 178 was moved within into the housing 160 to encapsulate a selected portion of the circuit board 166 and/or circuitry that needs waterproofing effects. Silicone gel was used in the practice of the invention because of the waterproofing and/or transmission reception enhancements that silicone gel provides. Next, the end cap 162 is secured on the end portion 174 of the housing 160 in any convenient manner, e.g., but not limiting the invention thereto, by an adhesive.

If necessary, the entire circuit board 166 can be covered to make certain that the circuit board circuitry, which needs the waterproofing effects of the silicone gel 178, as well as the improved communication effects for receiving and transmitting electrical signals, is waterproofed. The remainder of the housing can be filled with a polymer sealing material 180, such as polyurethane. The polyurethane 180 can then encapsulate a portion of the circuit board 166 and/or circuitry on the circuit board, which does not need the improved communications enhancement that the silicone gel 178 provides. As the silicone gel 178 and the polyurethane 180 are sequentially flowed into the interior of the housing 160 through the hole 176, air in the interior of the housing exits through hole 182. After the filling of the interior of the housing is completed, screws 184 (shown in FIG. 8) are secured in the holes 176 and 182.

The polyurethane cures resulting in a water-resistant/waterproof protection for the components of the circuit board. Further, the cured polyurethane in the holes 176 and 182 (see FIG. 9) secures the screws 184 in their respective holes. The water-resistant/waterproof transmitter/receiver, as shown in FIG. 8, has a portion of the electrical components, e.g., components 163, attached to the circuit board 166 encapsulated in the silicone gel 178, and a portion of the electrical components, e.g., components 164, attached to the circuit board 166 encapsulated in the polyurethane 180.

As can be appreciated, the invention is not limited to the number of cap wires 170 or the number of screws 172 connected to the cap wires, and the number depends on the number of water meter wires to have their communication wires (not shown) connected to the transmitter/receiver.

The resulting transmitter/receiver made by the present invention can be used in any type of environment, e.g., dry, wet, and/or moist environments, and is substantially less expensive to manufacture. Only covering the components of the circuit board with silicone gel and the remainder of the housing with a less expensive material, e.g., polyurethane, reduces the cost of manufacturing the transmitter/receiver.

The form of the invention shown and described above represents illustrative non-limiting embodiments of the invention. It is understood that various changes may be made without departing from the teachings of the invention defined by the claimed subject matter that follows.

1. A meter, comprising:
a meter body;
a meter register registered to the meter body, wherein the meter register transmits an RF signal therefrom;
a clamp attached to the meter; and
a transmitter/receiver received by the clamp, wherein the transmitter/receiver receives the RF signal transmitted by the meter register and transmits another signal to be read by a meter reading device.

2. A clamp for use with a meter having a meter body and a meter register that transmits a radio signal, the clamp comprising:
a body for receipt of the meter register, the body of the clamp having an arrangement to secure the body of the clamp to the meter body; and
a transmitter receiver for communication with the register via a radio signal attached to the clamp.

3. An improved meter for measuring material flow, wherein the meter is of the type having a meter body having a cavity through which material can flow, a material displacement arrangement in the cavity, the material displacement arrangement responsive to material moving through the meter, a register acted on by the material displacement arrangement, the register having components to determine the amount of flowed material to generate a signal having information regarding amount of flowed material through the meter, and to transmit the signal, wherein the transmitted signal has a predetermined distance, the improvement comprising:
a receiver mounting the meter body to receive the transmitted signal from the register defined as a first signal; and
a signal converter connected to the receiver and acting on the first signal to convert the first signal to a second signal, wherein transmission range of the second signal has a predetermined distance greater than the predetermined distance of the first signal.

4. The improved meter according to claim 3, wherein the meter is a water meter, the meter body comprises a passageway extending from the surface of the meter body to the cavity, and the register is a meter register, the meter register has a first portion and an opposite second portion with the first portion of the meter register in the passageway of the meter body adjacent to the material displacement arrangement and the second portion of the meter register extends out of the passageway beyond the meter body, and further comprising a signal transmitter, wherein the signal transmitter, the receiver, and the signal converter are mounted in a housing mounted on the meter body and encompassing a portion of the second portion of the meter register.

5. The improved meter according to claim 4, further comprising an engaging ring mounted on the second portion of the meter register, a platform secured to the engaging ring and having a support surface, wherein the housing is mounted on the support surface of the platform.

6. The improved meter according to claim 5, wherein the meter further comprises a securing ring receiving the second portion of the meter register and secured to the meter body, the securing ring and the meter register co-acting to prevent a water flow from the passageway as water flows through an inlet into the cavity, through the cavity past the measuring displacement arrangement to an outlet, the engaging ring supported on an outer surface portion of the securing ring.

7. The improved meter according to claim 6, wherein the securing ring has an upper surface and equally spaced tabs on a circumferential surface of the securing ring and the engaging ring includes a plurality of spaced flexible members having cut outs and a pair of spaced supporting blocks, wherein the engaging ring surrounds the second portion of the meter register and rests on the upper surface of the securing ring with the tabs extending through the cut outs and the spaced supporting blocks of the engaging ring supported on the upper surface of the securing ring.

8. The improved meter according to claim 4, wherein interior of the having silicone gel therein.

9. The improved meter according to claim 8, wherein the silicone gel fills a portion of the interior of the housing and the remainder of the interior of the housing is filled with a moisture-impervious material.

10. The improved meter according to claim 3, wherein the register includes a rotating arm having a magnet on a portion of the rotating arm and further comprising a pair of reed switches adjacent path of the rotating arm with the rotating arm as it moves along the path moves past the ends of each of the switches, wherein the magnet is not operative on the reed switches when the magnet is between the ends of each of the switches and is operative on adjacent ends of each of the switches when the magnet is equally spaced from the reed switches at their shortest distance from one another, and further comprising a microprocessor acting on signals from the reed switches to determine direction of arm rotation and units of water flowing through the meter.

11. An improved meter for measuring material flow, wherein the meter is of the type having a meter body having a cavity through which material can flow, a material displacement arrangement in the cavity responsive to material moving through the meter, a register acted on by the material displacement arrangement to determine the amount of flowed material, the register comprising a rotating arm mounted for rotation in a clockwise and a counterclockwise direction depending on the direction of the material flow, the improvement comprising:
a magnet on an end portion of the rotating arm; and
a pair of reed switches mounted outside the meter body and the register, and acted by the magnet as the arm moves past the reed switches.

12. The improved meter according to claim 11, wherein the meter is a water meter and the meter body comprises a passageway extending from a surface of the meter body to the cavity, and the register is a meter register, the meter register has a first portion and an opposite second portion with the first portion of the meter register in the passageway of the meter body adjacent to the material displacement arrangement and the second portion of the meter register extends out of the passageway beyond the meter body, and further comprising a housing mounted on a platform, the housing containing a signal transmitter and a microprocessor, the microprocessor connected to each of the reed switches and the reed switches mounted on the platform, and further comprising a mounting arrangement to mount the platform adjacent the meter register.

13. The improved meter according to claim 12, wherein the pair of reed switches are mounted adjacent the path of the rotating arm with the rotating arm as it moves along the path moves past the ends of each of the switches, wherein the magnet is not operative on the reed switches when the magnet is between the ends of each of the switches and is operative on adjacent ends of each of the switches when the magnet is equally spaced from the reed switches at their shortest distance from one another, and the microprocessor acts on signals from the reed switches to determine direction of arm rotation and units of water flowing through the meter.

14. The improved meter according to claim 13, further comprising an engaging ring circumscribing a portion of the second portion of the meter register and the platform secured to the engaging ring.

15. The improved meter according to claim 14, wherein the water meter further comprises a securing ring circumscribing a portion of the second portion of the meter register and secured to the meter body and the engaging ring supported on a surface of the securing ring.

16. The improved meter according to claim 15, wherein the securing ring has an upper surface and equally spaced tabs on a circumferential surface of the securing ring, and the engaging ring includes a plurality of spaced flexible members having cut outs and a pair of spaced supporting blocks, wherein the engaging ring and the supporting blocks are supported on the upper surface of the securing ring with the tabs extending through the cut outs of the flexible members.

17. The improved meter according to claim 11, wherein silicone gel is in the housing.

18. The improved meter according to claim 17, wherein the silicone gel fills a portion of the interior of the housing and the remainder of the interior of the housing is filled with a moisture-impervious material.

19. An improved transmitter and receiver of the type having a housing and components in the housing to receive a signal, convert the signal and transmit the signal, and a power source, the improvement comprising:
a material selected from the group of moisture-impervious or moisture-resistant material in the housing and covering a selected portion of components in the housing.

20. The improved transmitter according to claim 19, wherein the housing having the components is filled with a silicone gel.

21. The improved transmitter according to claim 20, wherein the silicone gel fills a portion of the interior of the housing and the remainder is filled with a different moisture-impervious or moisture-resistant material.

22. The improved transmitter according to claim 19, wherein the moisture-impervious material or moisture-resistant material is selected from the group of a halogenated polymeric material including polyvinylidene chloride, polyvinylidene fluoride, polyvinyl chloride or polytrichlorofluoro ethylene, moisture-impervious hot melts, silicone gel, and combinations thereof.

23. A method for manufacturing a transmitter/receiver for use with a water meter in a pit, comprising the steps of:
(a) providing a body having a cavity;
(b) attaching electronics to the body within the cavity;
(c) partially filling a cavity, defined by the body, with a silicone gel;
(d) attaching a cap to the body;
(e) filling the remainder of the body cavity with polyurethane; and
(f) permitting the polyurethane to cure.
